(19) United States
(12) Patent Application Publication
(10) Pub. No.: US 2011/0113046 A1
(43) Pub. Date: May 12, 2011

(54) INFORMATION PROCESSING APPARATUS, INFORMATION EXTRACTING METHOD, PROGRAM, AND INFORMATION PROCESSING SYSTEM

(75) Inventor: Masaaki Isozu, Tokyo (JP)

(73) Assignee: Sony Corporation, Tokyo (JP)

(21) Appl. No.: 12/917,606

(22) Filed: Nov. 2, 2010

(30) Foreign Application Priority Data
Nov. 9, 2009 (JP) 2009-256227

(51) Int. Cl. G06F 17/30

(52) U.S. Cl. 707/754; 707/E17.009; 707/E17.014

(57) ABSTRACT

There is provided an information processing apparatus including a data storage unit storing at least two rules for extracting information from a document written using a markup language, a selecting unit selecting, in accordance with an appearance frequency of a specific character string in at least one part of an input document written using the markup language, a rule to be applied to the part from the at least two rules stored in the data storage unit, and an extracting unit extracting information from the part using the rule selected by the selecting unit.

### BACKGROUND OF THE INVENTION

1. Field of the Invention

The present invention relates to an information processing apparatus, an information extracting method, a program, and an information processing system.

2. Description of the Related Art

As the Internet has grown, it has become common for web pages available on the Internet to include a variety of digital information. From the user's viewpoint, such digital information includes a mix of useful information and unnecessary information. Accordingly, methods for automatically extracting desired information from web pages are already being developed.

As one example, in “Wrapper induction: efficiency and expressiveness”, Artificial Intelligence, 2000, vol. 118, p 15-68, Nicholas Kushmerick proposes a method called “LR Wrapper”. According to LR Wrapper, a rule that sets the locations of tags placed before and after desired information in an HTML (HyperText Markup Language) document is defined in advance and information in a web page that matches the rule is extracted. However, since the LR Wrapper method carries out matching on entire web pages, there is the risk of unintended information being extracted when information on a plurality of different fields is included in a page. On the other hand, as other examples, Japanese Laid-Open Patent Publications No. 2007-279964 and 2004-70405 propose methods that divide a web page into a plurality of blocks and then match keywords against each block. As yet another example, Japanese Laid-Open Patent Publication No. 2007-47974 proposes a method that divides a web page into a plurality of blocks and then evaluates whether information should be extracted from each block.

One example application of the information extracting techniques described above is text communication, as represented by chat, electronic mail, and the like. For example, if information relating to a keyword, which has become a topic in text written during a chat or in an electronic mail, could be automatically obtained from the Internet or the like, enhanced communication may be realized by incorporating the obtained information in the text. In particular, during online text communication, such as chat, where real time response is required, it would be especially advantageous for an application to automatically extract information in place of the user to allow communication to proceed smoothly. Note that each piece of information obtained from the Internet or the like is referred to as a “snippet”. As one example, the LR Wrapper method described above can be said to be a technique for extracting snippets from a web page.

### SUMMARY OF THE INVENTION

However, the information extracting techniques described above do not yet have sufficient precision to automatically extract a variety of information from a large number of web pages. For example, when rules provided according to the LR wrapper method or the like are indiscriminately applied to a large number of web pages (or blocks), there has been the problem of an increased probability of unsuitable information being extracted due by rules that are unsuitable for the individual web pages (or blocks). Here, although it is possible to conceive a method where pairs of individual web pages (or blocks) and rules are defined in advance, the cost of defining such pairs in advance is not negligible and it has been difficult to apply this method to unknown web pages.

On the other hand, it is believed that if it were possible to adaptively select the rules to be applied to information sources (that is, web pages, blocks inside a web page, or the like) according to the characteristics of each information source, it might be possible to improve the precision of the information that could be automatically extracted.

In light of the foregoing, it is desirable to provide a novel and improved information processing apparatus, information extracting method, program, and information processing system that are capable of adaptively selecting rules for extracting information that are to be applied to information sources such as web pages or blocks inside a web page.

According to an embodiment of the present invention, there is provided an information processing apparatus including a data storage unit storing at least two rules for extracting information from a document written using a markup language, a selecting unit selecting, in accordance with an appearance frequency of a specific character string in at least one part of an input document written using the markup language, a rule to be applied to the part from the at least two rules stored in the data storage unit, and an extracting unit extracting information from the part using the rule selected by the selecting unit.

The specific character string may be at least one tag that is capable of being used in the markup language.

The selecting unit may select a rule to be applied to the part also in accordance with an appearance frequency of at least one character string other than a tag in the part.

The information processing apparatus may further include an analyzing unit generating from the input document, based on definition data that defines hierarchical relationships in a document structure between at least two types of tag in the markup language, a tree structure in which at least tags included in the definition data and text relating to the tags are set as nodes. The selecting unit may select a rule to be applied to each part of the input document, each part corresponding to a partial tree of a specific depth in the tree structure generated by the analyzing unit.

The information processing apparatus may further include a database storing information extracted on a part-by-part basis from the at least one part of the input document by the extracting unit, and a searching unit searching the database for information that matches a keyword received from another information processing apparatus.

The database may store the information extracted from each part of the input document in association with a heading character string corresponding to the part from which the information was extracted. The searching unit may obtain information associated with a heading character string that matches the keyword from the database as a search result.

The searching unit may transmit information, which has been selected out of the information obtained from the database in accordance with a limiting condition relating to display received from said another information processing apparatus, to said another information processing apparatus.

The data storage unit may store each pattern, out of at least two patterns classified in accordance with an appearance frequency of the specific character string, in association with each rule out of the at least two rules.

According to another embodiment of the present invention, there is provided an information extracting method that uses an information processing apparatus including a data storage unit storing at least two rules for extracting information from a document written using a markup language, the information extracting method including the steps of selecting, in accordance with an appearance frequency of a specific character string in at least one part of an input document written using the markup language, a rule to be applied to the part from the at least two rules stored in the data storage unit, and

extracting information from the part using the selected rule.

According to another embodiment of the present invention, there is provided a program for causing a computer, which controls an information processing apparatus including a data storage unit storing at least two rules for extracting information from a document written using a markup language, to function as a selecting unit selecting, in accordance with an appearance frequency of a specific character string in at least one part of an input document written using the markup language, a rule to be applied to the part from the at least two rules stored in the data storage unit, and an extracting unit extracting information from the part using the rule selected by the selecting unit.

According to another embodiment of the present invention, there is provided an information processing system including a terminal apparatus that transmits a search request including a search keyword and displays, on a user interface, information provided as a response to the search request, and an information processing apparatus including a data storage unit storing at least two rules for extracting information from a document written using a markup language, a selecting unit selecting, in accordance with an appearance frequency of a specific character string in at least one part of an input document written using the markup language, a rule to be applied to the part from the at least two rules stored in the data storage unit, an extracting unit extracting information from the part using the rule selected by the selecting unit, a database storing information extracted from each part out of the at least one part of the input document by the extracting unit, and a searching unit obtaining information, which matches a search keyword received from the terminal apparatus, from the database and transmitting the obtained information to the terminal apparatus.

According to the embodiments of the present invention described above, it is possible to provide an information processing apparatus, an information extracting method, a program, and an information processing system that can adaptively select rules for extracting information that are to be applied to information sources such as web pages or blocks inside a web page.

### BRIEF DESCRIPTION OF THE DRAWINGS

FIG. 1 is a diagram useful in explaining an overview of an information processing system according to an embodiment of the present invention;

FIG. 2 is a block diagram showing one example of the configuration of an information processing apparatus according to an embodiment of the present invention;

FIG. 3 is a block diagram showing one example of the detailed configuration of an analyzing unit;

FIG. 4 is a diagram useful in explaining one example of a display content when a document written using a markup language is displayed by a browser;

FIG. 5 is a diagram useful in showing the document shown in FIG. 3 in text format;

FIG. 6 is a diagram useful in explaining one example of a first tree structure generated from the document shown in FIG. 3 by a parser of the analyzing unit;

FIG. 7 is a diagram useful in explaining one example of an input document in which “h” tags are used;

FIG. 8 is a diagram useful in explaining one example of a first tree structure generated from the input document shown in FIG. 7;

FIG. 9 is a diagram useful in explaining one example of a display content when the input document shown in FIG. 7 is displayed by a browser;

FIG. 10 is a diagram useful in explaining one example of definition data that defines hierarchical relationships between tags;

FIG. 11 is a flowchart showing one example of the flow of a tree structure converting process;

FIG. 12 is a diagram useful in explaining one example of a second tree structure generated as a result of the tree structure converting process;

FIG. 13 is a diagram useful in explaining an example of a rule written in accordance with the grammar of LR Wrapper;

FIG. 14 is a diagram useful in explaining another example of a rule written in accordance with the grammar of LR Wrapper;

FIG. 15A is a diagram useful in explaining one example of a data structure relating to rules for extracting information;

FIG. 15B is a diagram useful in explaining another example of a data structure relating to rules for extracting information;

FIG. 16 is a block diagram showing one example of a configuration of an information processing apparatus for learning associations between rules and appearance frequency patterns of specific character strings;

FIG. 17 is a flowchart showing one example of a flow of a learning process for learning associations between rules and appearance frequency patterns;

FIG. 18 is a diagram useful in explaining examples of blocks identified from a second tree structure;

FIG. 19 is a diagram useful in explaining an information extracting process that uses a selected rule;

FIG. 20 is a diagram useful in explaining examples of snippets stored in a database as a result of extracting information;

FIG. 21 is a block diagram showing one example of the configuration of a terminal apparatus according to an embodiment of the present invention;

FIG. 22 is a diagram useful in explaining one example of a screen displayed on a screen of the terminal apparatus;

FIG. 23 is a sequence diagram showing one example of the flow of provision of snippets from the information processing apparatus to the terminal apparatus; and

FIG. 24 is a block diagram showing one example of the configuration of a general-purpose computer.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Embodiments of the present invention are described in the order indicated below.

1. Overview of Information Processing System

2. Example Configuration of Information Processing Apparatus
2-1. Analysis of Input Document
2-2. Configuration of Data Storage Unit
2-3. Rule Learning
2-4. Extraction and Storage of Snippets
2-5. Provision of Snippets

3. Example Configuration of Terminal Apparatus
3-1. Example of User Interface
3-2. Search for Snippets

4. Example of Hardware Configuration

5. Conclusion

### 1. OVERVIEW OF INFORMATION PROCESSING SYSTEM

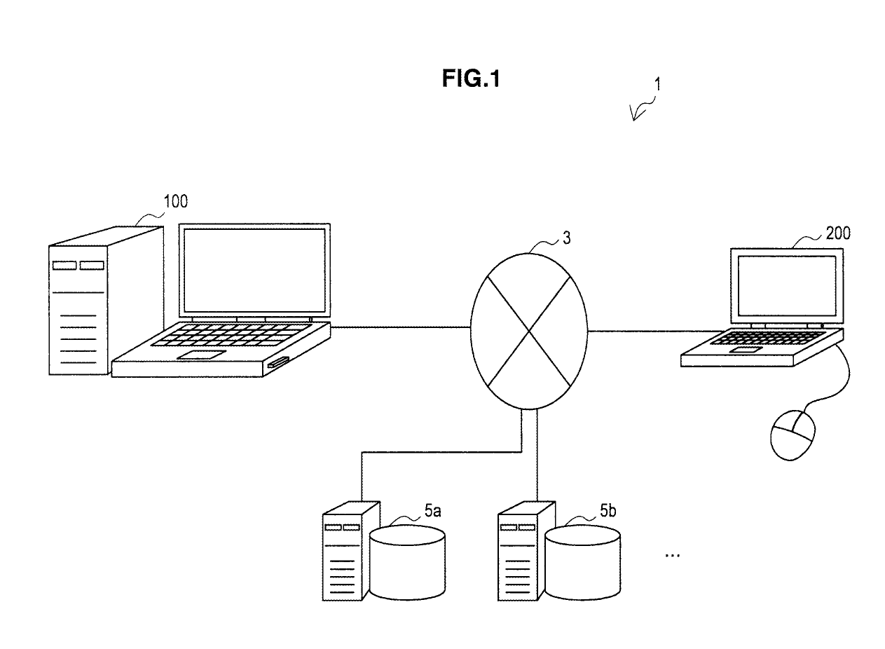

First, an overview of an information processing system according to an embodiment of the present invention will be described. FIG. 1 is a diagram useful in explaining an overview of an information processing system 1 according to an embodiment of the present invention. As shown in FIG. 1, the information processing system 1 includes an information processing apparatus 100 and a terminal apparatus 200. The information processing apparatus 100 is connected to the terminal apparatus 200 via a network 3. At least one web server 5a, 5b . . . is also connected to the network 3.

The information processing apparatus 100 is a device for obtaining a document written using a markup language via the network 3 and extracting information from the obtained document. For example, the information processing apparatus 100 may be a general-purpose computer such as a PC (Personal Computer) like that shown in FIG. 1 or a workstation. As an alternative example, the information processing apparatus 100 may be a digital home appliance set up on a home network. In the present embodiment, the information processing apparatus 100 operates as a server that provides information, which has been extracted using adaptively selected rules, to the terminal apparatus 200 that acts as a client.

The terminal apparatus 200 is a device for obtaining the information extracted by the information processing apparatus 100 via the network 3 and presenting the obtained information to a user. The terminal apparatus 200 may also be a general-purpose computer such as a PC or a workstation. As alternative examples, the terminal apparatus 200 may be a portable terminal apparatus, which may include mobile phones and the like, a digital home appliance, or other such device.

The network 3 is a communication network that connects the information processing apparatus 100 and the terminal apparatus 200. The network 3 may be an arbitrary communication network such as the Internet, an IP-VPN (Internet Protocol-Virtual Private Network), a dedicated line, a LAN (Local Area Network), or a WAN (Wide Area Network). The network 3 may be wired or wireless.

The web servers 5a and 5b are web servers that are each capable of being accessed from the information processing apparatus 100 via the network 3. The web server 5a or 5b transmits a web page, which is one example of a document written using a markup language, in response to a request from the information processing apparatus 100. Note that the web servers 5a and 5b may both be typical web servers. In place of the web servers 5a and 5b, it is possible to provide a data server (or file server) that stores documents written using a markup language. In addition, such servers may be operated by a different entity to the entity who operates the information processing apparatus 100.

In the information processing system 1 described as one example above, the information processing apparatus 100 obtains a document, such as a web page, via the network 3 from the web server 5a or 5b or from a different source. The information processing apparatus 100 then extracts information from the obtained web page and stores the extracted information in a database. Individual pieces of information stored by the information processing apparatus 100 are referred to as “snippets” in the present specification. In addition, the information processing apparatus 100 provides snippets that have been stored in the database to the terminal apparatus 200 in response to a request from the terminal apparatus 200. First, one example of the specific configuration of this type of information processing apparatus 100 will be described in detail below.

### 2. EXAMPLE CONFIGURATION OF INFORMATION PROCESSING APPARATUS

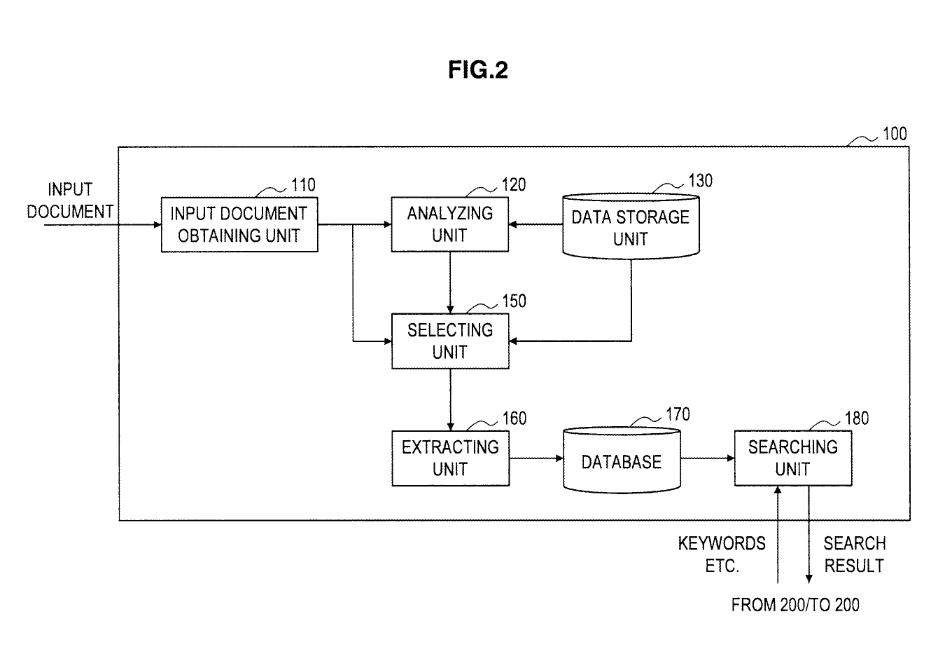

FIG. 2 is a block diagram showing an example configuration of the information processing apparatus 100 according to the present embodiment. As shown in FIG. 2, the information processing apparatus 100 mainly includes an input document obtaining unit 110, an analyzing unit 120, a data storage unit 130, a selecting unit 150, an extracting unit 160, a database 170, and a searching unit 180.

### 2-1. Analysis of Input Document

As one example, the input document obtaining unit 110 obtains a document written using a markup language from the web server 5a or 5b illustrated in FIG. 1 (or from another data server or the like). As examples, the markup language may be SGML (Standard Generalized Markup Language), XML (eXtensible Markup Language)that is a subset of SGML, HTML (HyperText Markup Language), Tex, or the like. In a document written using a markup language, it is possible to designate text structure (such as paragraph breaks and lists), layout, and the like using tags (referred to as “commands” in some languages) that mark up the text. The input document obtaining unit 110 then outputs the obtained input document to the analyzing unit 120.

From the input document obtained by the input document obtaining unit 110, the analyzing unit 120 generates a tree structure in which the tags that can be used in the markup language used to write the input document and text relating to such tags are set as nodes. More specifically, based on definition data that defines hierarchical relationships in a document structure between at least two types of tag in the markup language described above, the analyzing unit 120 generates a tree structure, in which at least the tags included in the definition data and text relating to such tags are set as nodes, from the input document.

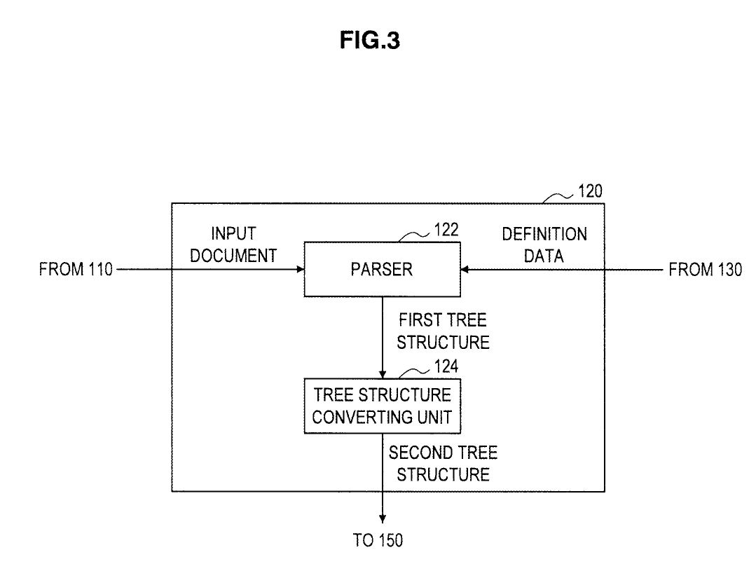

FIG. 3 is a block diagram showing one example of the detailed configuration of the analyzing unit 120. As shown in FIG. 3, the analyzing unit 120 includes a parser 122 and a tree structure converting unit 124. Out of these components, the parser 122 parses the input document written using a markup language. For example, when the input document is a document in HTML format, the parser 122 may be a well-known HTML parser. On the other hand, the tree structure converting unit 124 converts a first tree structure obtained as a result of a parsing process carried out by the parser 122 to a second tree structure that is more suited to extracting information.

### Parsing Process

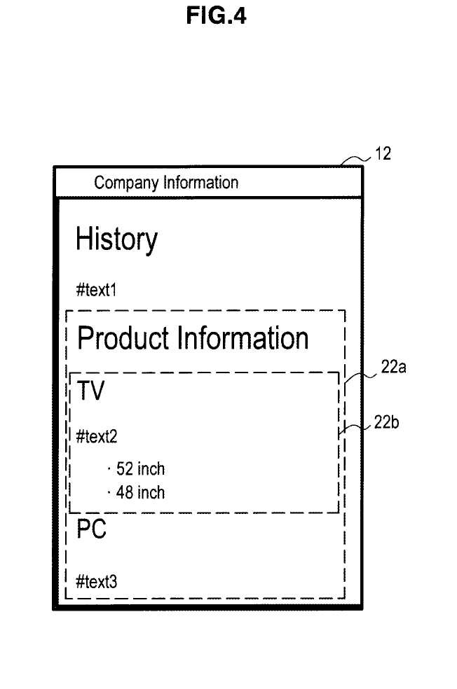

The first tree structure generated by the parsing process carried out by the parser 122 will now be described with reference to FIGS. 4 to 6.

FIG. 4 is a diagram useful in explaining one example of a screen displayed when an HTML document, which is one example of a document handled by the present embodiment, has been interpreted by a web browser. As shown in FIG. 4, a web page 12 that has “Company Information” written in the title bar is displayed.

The web page 12 includes two large headings, “History” and “Product Information”, which have a large character size. A character string “#text1” is displayed below the heading “History”. Two medium headings, “TV” and “PC”, that have an intermediate character size are displayed below the heading “Product Information”. In addition, a character string “#text2” and a list of two items (“52 Inch”, “48 Inch”) corresponding to the sizes of products are displayed below the heading “TV”. A character string “#text3” is displayed below the heading “PC”.

A viewer who views this type of web page 12 can understand for example that the company being introduced by the web page 12 has “TV” and “PC” as products and that product information is written in a screen region 22a. As another example, the viewer can also understand that product information relating to “TV” is written in a screen region 22b.

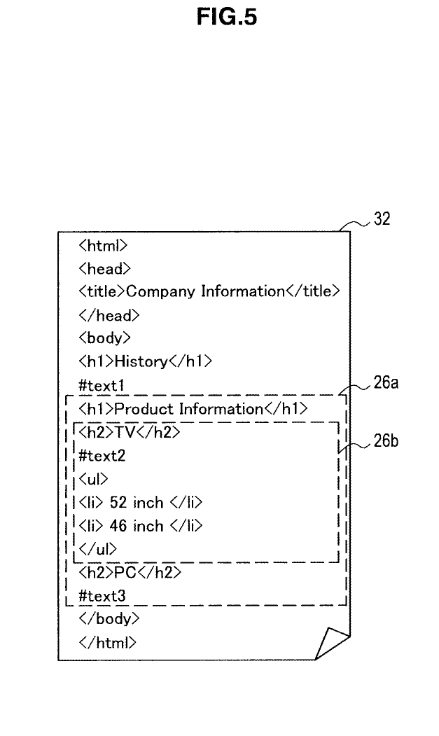

On the other hand, FIG. 5 is a diagram showing the content of the HTML document shown in FIG. 4 in text format without the content being interpreted by a web browser.

FIG. 5 shows an HTML document 32 that has been marked up with HTML tags. The content of the HTML document 32 is written with a nested structure in which start tags and end tags are used. Out of such content, a block 26a that forms part of the document is the part that corresponds to the screen region 22a in FIG. 4. Similarly, a block 26b is the part that corresponds to the screen region 22b.

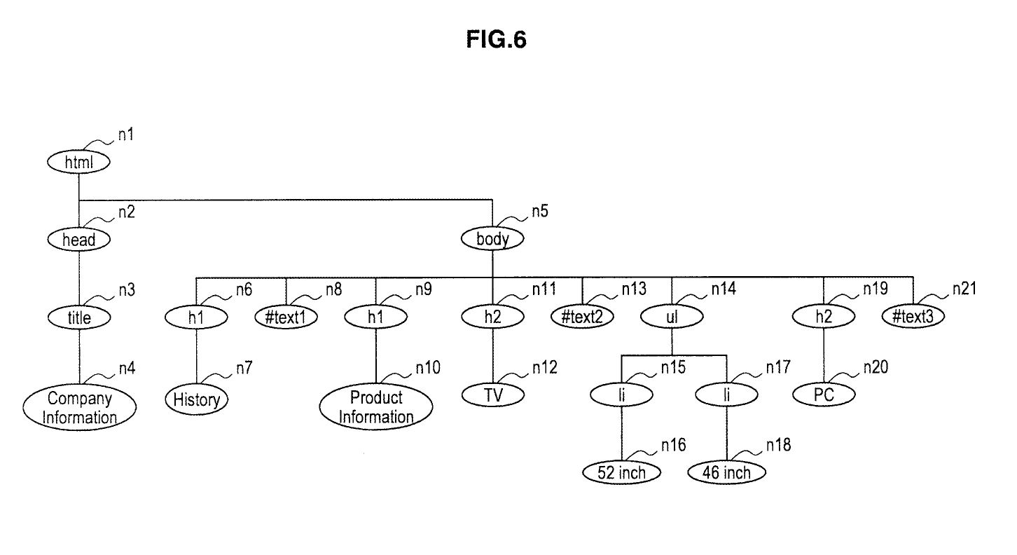

FIG. 6 is a diagram showing one example of the first tree structure that is generated from the HTML document 32 shown in FIG. 5 as a result of the parsing process and has HTML tags and text marked up using HTML tags as nodes.

As shown in FIG. 6, the HTML document 32 is constructed of 21 nodes numbered n1 to n21. Out of such nodes, the node n2 (the “head” tag) and the node n5 (the “body” tag) are positioned below the node n1 (the “html” tag). The node n3 (the “title” tag) is positioned below the node n2, and the node n4 (the text “Company Information”) is positioned below the node n3. Meanwhile, eight nodes numbered n6, n8, n9, n11, n13, n14, n19, and n21 are positioned in a row below the node n5, with further lower-order nodes being positioned below such eight nodes. Out of such nodes, the nodes n9 to n21 correspond to the block 26a in FIG. 5. Similarly, the nodes n11 to n18 correspond to the block 26b in FIG. 5.

Here, as one example, when matching is carried out using the keyword “product information” to automatically obtain product information of the company from the HTML document 32, the node n10 in FIG. 6 matches the keyword. However, as described above, since the nodes n9 to n21 that actually correspond to product information are only some of the nodes n6 to n21 that are positioned in a row, it is difficult to appropriately decide which nodes correspond to product information from the node n10 specified by the matching. This is also the case when automatically obtaining other arbitrary information, for example information relating to the product “TV” or information relating to the product “PC”.

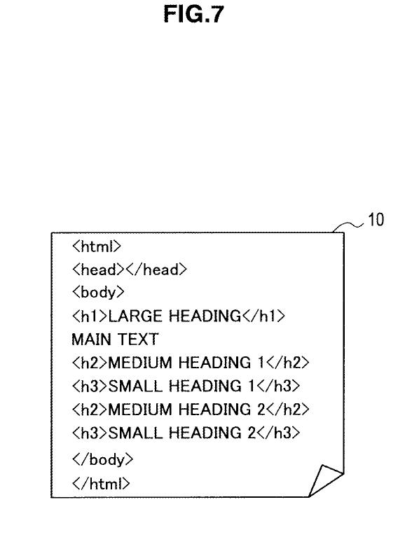

Accordingly, the first tree structure generated by the parser 122 and illustrated in FIG. 6 is not suited to extracting meaningful information. For this reason, as described below with reference to FIGS. 7 to 12, the tree structure converting unit 124 converts the first tree structure described above to the second tree structure that is more suited to the extraction of information.

### Tree Structure Converting Process

As described above, the tree structure converting unit 124 converts the first tree structure obtained as a result of the parsing process by the parser 122 to the second tree structure that is more suited to the extraction of information. In the present embodiment, the expression “second tree structure” refers to a tree structure generated based on definition data that defines hierarchical relationships in the document structure between at least two types of tag in a markup language. The second tree structure sets at least tags included in the definition data and text relating to such tags as nodes.

As one example, the definition data used in the tree structure converting process carried out by the tree structure converting unit 124 may be data in which hierarchical relationships in the document structure are defined between tags relating to at least headings out of the tags used in the input document. As one example, the tags relating to headings correspond to “h” tags in HTML.

FIGS. 7 to 9 are diagrams useful in explaining hierarchical relationships in the document structure relating to the “h” tags.

First, FIG. 7 shows a document 10 as one example written using the tags “h1”, “h2”, and “h3”. In FIG. 7, a “body” part of the document 10 includes one large heading marked up using “h1” tags, a main text positioned below the large heading, two medium headings marked up using “h2” tags, and two small headings marked up using “h3” tags.

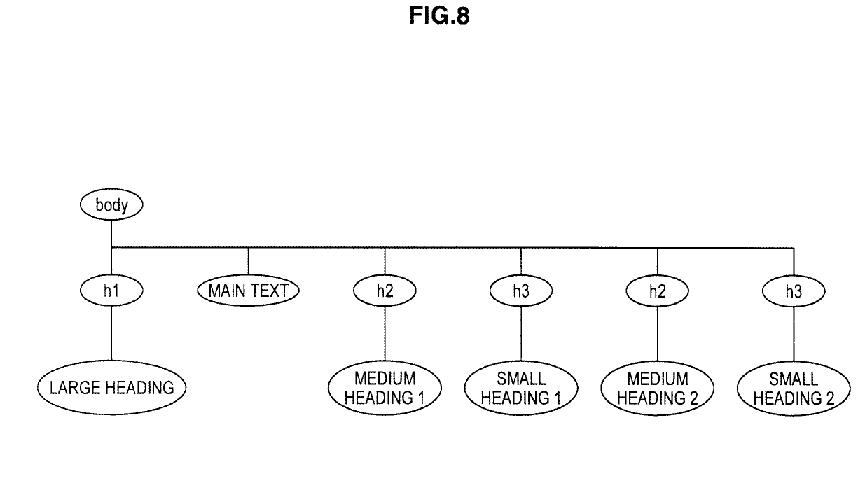

FIG. 8 shows a part below the “body” tag out of the first tree structure obtained by structural analysis of the document 10 shown in FIG. 7 using an HTML parser. In FIG. 8, tag nodes corresponding to the three types of “h” tag “h1”, “h2”, and “h3” and a node corresponding to the “main text” are all positioned in a row one level below the “body” tag. Nodes of heading character strings that are marked up using the respective “h” tags are positioned below the respective nodes of the “h” tags.

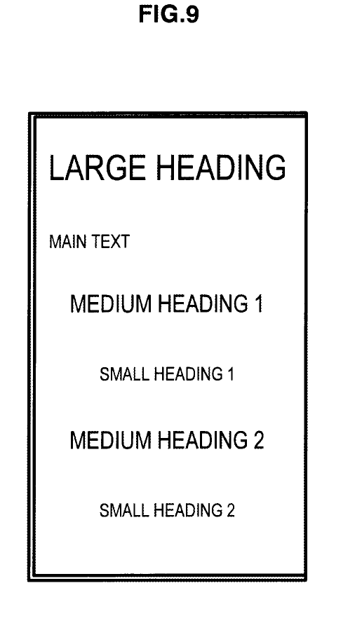

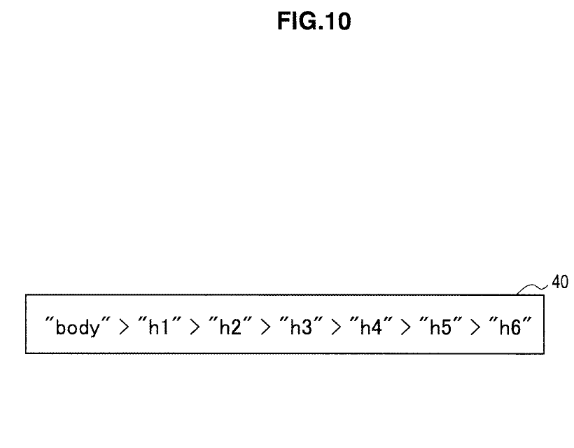

FIG. 9 shows an example display when a web browser interprets and displays the document 10 shown in FIG. 7. As shown in FIG. 9, “large heading” is understood to include “main text” and all of the other headings in a heading range thereof. In the same way, “medium heading 1” may be understood to include “small heading 1” and “medium heading 2” to include “small heading 2” in the respective heading ranges thereof. That is, even when “h” tags in HTML are used in a row as in the first tree structure in FIG. 8, inclusive and non-inclusive relationships in the document structure between the marked-up text, or in other words hierarchical relationships, are represented at least visually. To do so, definition data such as that shown for example in FIG. 10 that defines hierarchical relationships in the document structure between the “h” tags is provided in the present embodiment.

As shown in FIG. 10, the hierarchical relationships relating to the “h” tags are defined in definition data 40 as “body”>“h1”>“h2”>“h3”>“h4”>“h5”>“h6”. The inequality sign (“>”) in the definition data 40 shows that the tag on the left of the sign is positioned on a higher level than the tag on the right. In the definition data 40, the hierarchical relationships between the “h” tags from “h1” to “h6” are defined in numerical order and the “body” tag is defined on a higher level than all of the “h” tags. As one example, the definition data described above is stored in advance in the data storage unit 130 shown in FIG. 2 or the like. The tree structure converting unit 124 uses such definition data to convert the first tree structure described above to the second tree structure.

Note that the definition data is not limited to data that defines hierarchical relationships in the document structure relating to the “body” tag and the “h” tags. For example, the tags whose hierarchical relationships are defined by the definition data may also include a “font” tag that designates a font size of text in HTML. The tags whose hierarchical relationships are defined by the definition data may also include other arbitrary tags, such as tags that designate specified classes defined in a style sheet using attributes.

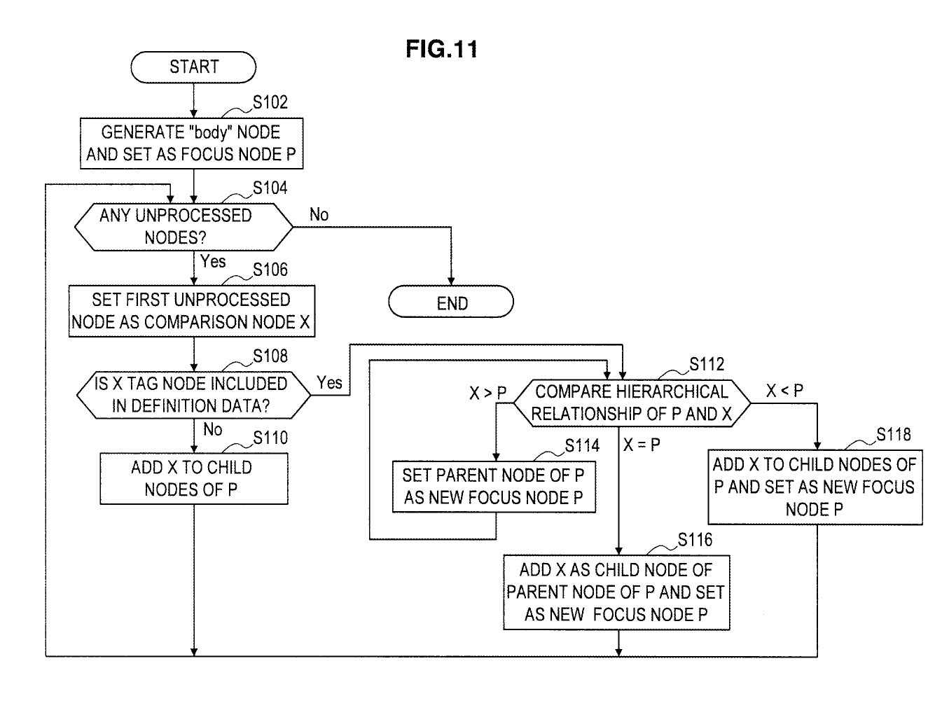

FIG. 11 is a flowchart showing one example of the flow of the tree structure converting process carried out by the tree structure converting unit 124.

As shown in FIG. 11, the tree structure converting unit 124 first generates a “body” node corresponding to the “body” tag and sets the “body” node as a start node of the second tree structure. The tree structure converting unit 124 then sets the “body” node as a focus node P (step S102).

Next, the tree structure converting unit 124 determines whether any unprocessed nodes remain in the first tree structure (step S104). Here, if an unprocessed node remains, the processing proceeds to S106. On the other hand, if no unprocessed nodes remain, the processing ends.

In S106, the tree structure converting unit 124 sets a first node out of the unprocessed nodes in the first tree structure as a comparison node X (step S106). Here, the first node may be a node that corresponds to a tag or text written closest to the start of a document. As an alternative example, the first node may be the first node to be found during a depth-first search of the first tree structure. For example, in the first tree structure shown in FIG. 8, when nodes up to the “body” node have been processed, the “h1” node is the first unprocessed node. Conversely, when nodes up to the “h1” node have been processed, the “large heading” node is the first unprocessed node.

Next, the tree structure converting unit 124 determines whether the comparison node X is a tag node corresponding to a tag for which a hierarchical relationship in the document structure is defined in the definition data described above (step S108). As one example, when the definition data 40 shown in FIG. 10 is defined, if the comparison node X is a node corresponding to a “body” tag or an “h” tag in a range of “h1” to “h6”, the processing proceeds to S112. On the other hand, if the comparison node X is not one of the nodes listed above (for example, a node corresponding to a heading character string marked up by tags or corresponding to the main text), the processing proceeds to S110.

In S110, the comparison node X set in S106 is added to child nodes of the focus node P (step S110). For example, if the focus node P is the “h1” node in the first tree structure shown in FIG. 8 and the comparison node X is the “main text” node, the “main text” node is added below the “h1” node in the second tree structure. As another example, if the focus node P is the “h2” node in the first tree structure shown in FIG. 8 and the comparison node X is the “medium heading 1” node, the “medium heading 1” node is added below the “h2” node in the second tree structure. After this, the processing returns to S104 and it is again determined whether there are any unprocessed nodes.

On the other hand, if the comparison node X is a tag node corresponding to a tag for which a hierarchical relationship is defined in the document structure, in S112, the hierarchical relationship between the focus node P and the comparison node X is compared (step S112). For example, when the definition data 40 shown in FIG. 10 is defined, if the focus node P is the “body” node and the comparison node X is a tag node corresponding to an “h” tag, it is determined that the comparison node X<the focus node P. As another example, if the focus node P is an “h1” node and the comparison node X is also an “h1” node, it is determined that the comparison node X=the focus node P. As yet another example, if the focus node P is an “h2” node and the comparison node X is an “h1” node, it is determined that the comparison node X>the focus node P. Here, if the comparison node X>the focus node P, the processing proceeds to S114. If the comparison node X=the focus node P, the processing proceeds to S116. If the comparison node X<the focus node P, the processing proceeds to S118.

Next, if the comparison node X>the focus node P, in S114 the parent node of the focus node P is set as the new focus node P (step S114). For example, if the focus node P is the first “h3” node in the first tree structure shown in FIG. 8 and the comparison node X is the second “h2” node, the first “h2” node that is the parent of the first “h3” node is set once again as the focus node P. The processing then returns to S112 and the hierarchical relationship between the focus node P and the comparison node X is compared again.

If the comparison node X=the focus node P, in S116 the comparison node X is added as a child node of the parent node of the focus node P (i.e., a sibling node of the focus node P) in the second tree structure. As one example, if the focus node P is the first “h2” node in the first tree structure shown in FIG. 8 and the comparison node X is the second “h2” node, the second “h2” node is added as a child node of the “h1” node that is the parent node of the first “h2” node. The added second “h2” node is then set as the new focus node P. After this, the processing returns to S104 and it is again determined whether there are any unprocessed nodes.

If the comparison node X<the focus node P, in S118, the comparison node X is added as a child node of the focus node P in the second tree structure. For example, if the focus node P is the first “h2” node in the first tree structure shown in FIG. 8 and the comparison node X is the first “h3” node, the “h3” node is added as a child node of the first “h2” node. The added second “h3” node is then set as the new focus node P. After this, the processing returns to S104 and it is again determined whether there are any unprocessed nodes.

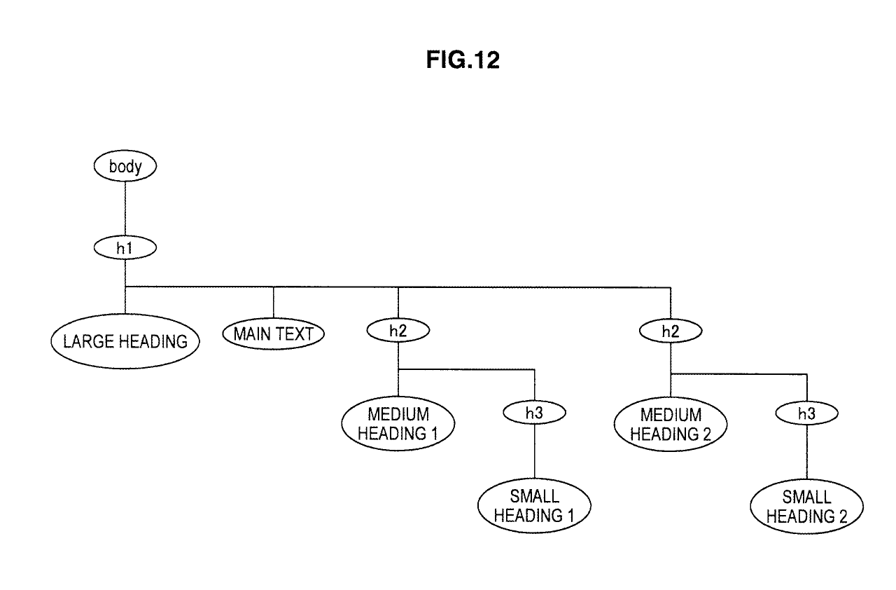

As a result of the tree structure converting process carried out by the tree structure converting unit 124, the second tree structure shown in FIG. 12 is generated from the first tree structure shown as one example in FIG. 8.

As shown in FIG. 12, the “h1” node is positioned on the first level below the “body” node, and “large heading”, “main text”, the first “h2” node, and the second “h2” node are positioned one level below the “h1” node. The “medium heading 1” node or the “medium heading 2” node and an “h3” node are positioned one level below each “h2” node. In addition, the “small heading 1” node or the “small heading 2” node is positioned one level below each “h3” node. The second tree structure corresponds to the inclusive and non-inclusive relationships in the document structure of the document 10 visually represented in FIG. 9. The tree structure converting unit 124 outputs data that expresses the second tree structure in XML format, for example, to the selecting unit 150.

### 2-2. Configuration of Data Storage Unit

As one example, the data storage unit 130 is constructed using a storage medium such as a hard disk drive or a semiconductor memory, and stores in advance the definition data described above that is used by the tree structure converting unit 124 of the analyzing unit 120. The data storage unit 130 also stores at least two rules for extracting information from a document written using a markup language. The rules stored by the data storage unit 130 may be rules written according to the grammar of LR wrapper, for example. As an alternative, the rules stored in the data storage unit 130 may be equations using regular expressions, for example. More typically, the rules stored by the data storage unit 130 may be a tool for designating conditions for extracting information from a document written using a markup language.

### Example Rules

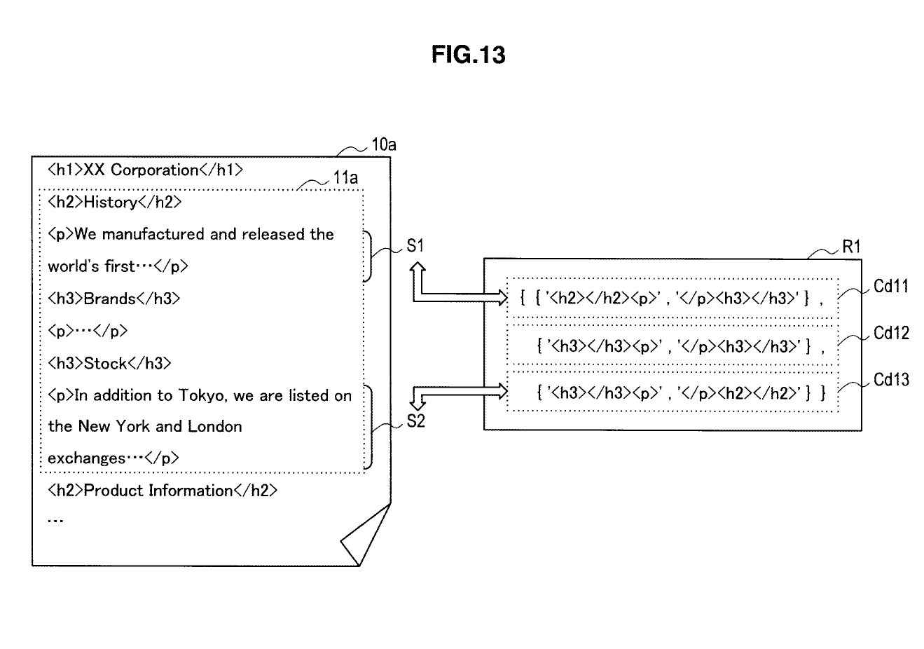

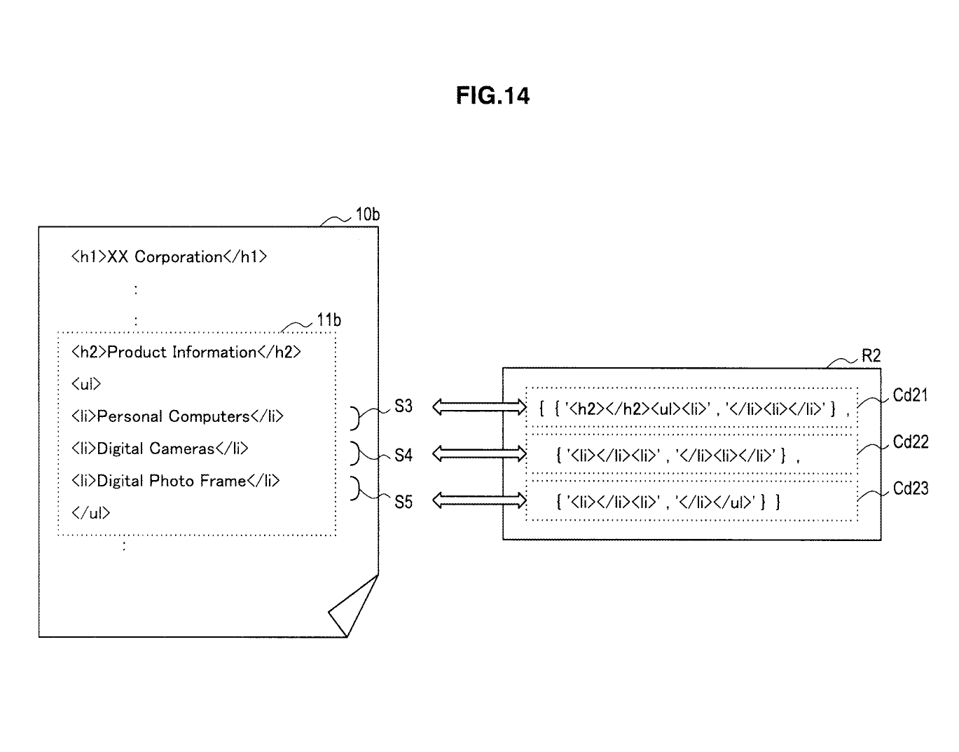

FIGS. 13 and 14 are diagrams showing examples of rules written in accordance with the grammar of LR Wrapper.

FIG. 13 shows a rule R1 as a first example. The rule R1 includes three conditions Cd11, Cd12, and Cd13. Out of these conditions, the first condition Cd11 matches documents that have a pattern where the tags “<h2></h2><p>” appear first and the tags “</p><h3></h3>” appear later. The second condition Cd12 matches documents that have a pattern where the tags “<h3></h3><p>” appear first and the tags “</p><h3></h3>” appear later. The third condition Cd13 matches documents that have a pattern where the tags “<h3></h3><p>” appear first and the tags “</p><h2></h2>” appear later. The rule R1 that includes such conditions matches a part 11a of a document 10a shown in FIG. 13, for example. As one example, information S1 (“We manufactured and released the world's first . . . ”) may be extracted according to the first condition Cd11. As another example, information S2 (“In addition to Tokyo, we are listed on the New York and London exchanges”) may be extracted according to the third condition Cd13. Note that although other character strings may be extracted according to the second condition Cd12, such character strings have been omitted from the drawings.

FIG. 14 shows a rule R2 as a second example. The rule R2 includes three conditions Cd21, Cd22, and Cd23. Out of these conditions, the first condition Cd21 matches documents that have a pattern where the tags “<h2></h2><ul><li>” appear first and the tags “</li><li></li>” appear later. The second condition Cd22 matches documents that have a pattern where the tags “<li></li><li>” appear first and the tags “</li><li></li>” appear later. The third condition Cd23 matches documents that have a pattern where the tags “<li></li><li>” appear first and the tags “</li></ul>” appear later. The rule R2 that includes such conditions matches a part 11b of a document 10b shown in FIG. 14, for example. As one example, information S3 (“Personal Computers”) may be extracted according to the first condition Cd21. As another example, information S4 (“Digital Cameras”) may be extracted according to the second condition Cd22. As yet another example, information S5 (“Digital Photo Frames”) may be extracted according to the third condition Cd23.

Note that the rules R1 and R2 shown in FIGS. 13 and 14 are mere examples. At least two of such rules for extracting information are stored in advance in the data storage unit 130 using the data structure described below.

### Example Data Structure

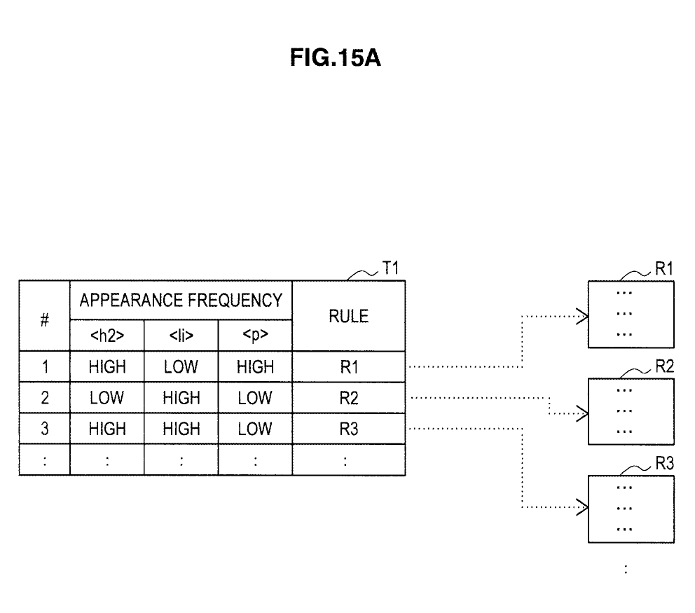

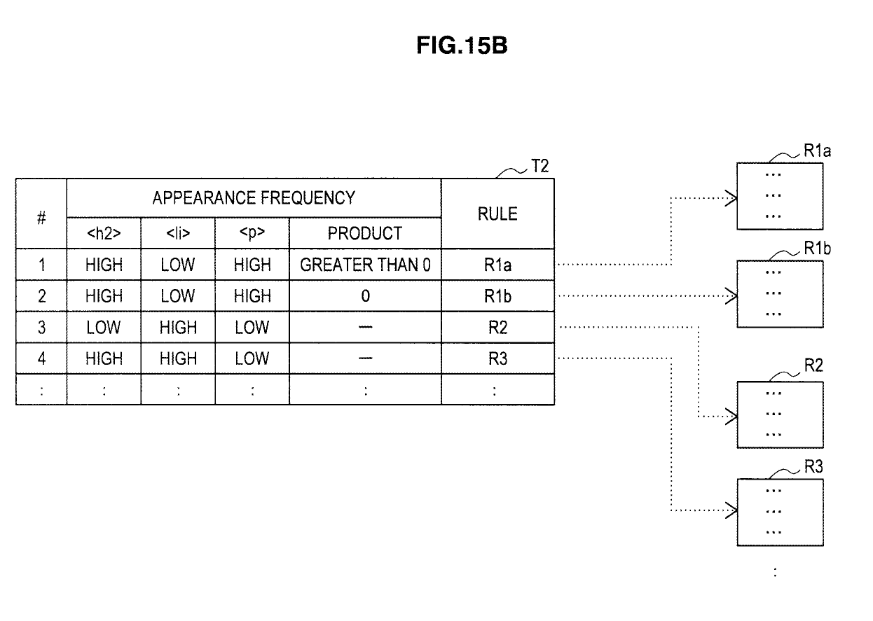

As one example, the data storage unit 130 stores appearance frequencies of specific character strings in at least one part of the input document written using a markup language in association with rules to be applied to such part of the input document. FIG. 15A is a diagram useful in explaining one example of a data structure in the data storage unit 130 that relates to the rules for extracting information described above.

FIG. 15A shows a rule management table T1 for associating appearance frequencies of specific character strings in at least one part of the input document and rules to be applied to such part of the input document. In the present embodiment, the specific character strings are three types of tag, “h2”, “li”, and “p”, that can be used in HTML. In the rule management table T1, the appearance frequencies of the respective tags are classified into two ranks given as “high” and “low”. Here, in accordance with the appearance frequencies of the three types of tag, it is possible to define a maximum of eight appearance frequency patterns.

For example, the first entry in the rule management table T1 shows that a pattern in which the appearance frequency of “h2” is “high”, the appearance frequency of “li” is “low”, and the appearance frequency of “p” is “high” is associated with the rule R1. The second entry in the rule management table T1 shows that a pattern in which the appearance frequency of “h2” is “low”, the appearance frequency of “li” is “high”, and the appearance frequency of “p” is “low” is associated with the rule R2. The third entry in the rule management table T1 shows that a pattern in which the appearance frequency of “h2” is “high”, the appearance frequency of “li” is “high”, and the appearance frequency of “p” is “low” is associated with the rule R3.

Note that tags aside from the three types of tag shown in FIG. 15A may be used to distinguish the appearance frequency patterns to be associated with the respective rules. Character strings (referred to as “text”) that are not tags may also be used to further distinguish between the appearance frequency patterns. For example, even when the same arrangement of tags is used, in many cases the content of information differs in accordance with the heading character strings (“Products”, “Services”, or the like) included therein. In cases where it is desirable to extract only some types of information, it is preferable to distinguish between patterns by also considering the appearance frequency of one or more specified heading character strings (for example, “Products”).

FIG. 15B is a diagram useful in explaining another example of the data structure in the data storage unit 130 that relates to rules for extracting information. FIG. 15B shows a rule management table T2 that uses the text “Products” as an identification key in addition to the three types of tag “h2”, “li”, and “p” that can be used in HTML. In the rule management table T2, a pattern in which the appearance frequency of “h2” is “high”, the appearance frequency of “li” is “low”, and the appearance frequency of “p” is “high” is further classified into two patterns according to the appearance frequency of the text “Products”. In one of such patterns (the first entry), the appearance frequency of the text “Products” is “greater than 0” and the pattern is associated with the rule R1a. In the other of such patterns (the second entry), the appearance frequency of the text “Products” is “zero” and the pattern is associated with the rule R1b. Since the other entries are the same as in FIG. 15A, description thereof is omitted here. In this way, by distinguishing rules further in accordance with the appearance frequency of text aside from tags, it is possible to further increase the precision for extracting information.

Here, as examples, the “appearance frequency” of a character string (that is, a tag or text) may be the number of appearances of such character string in one input document or in one block. The “appearance frequency” of a character string may alternatively be the number of appearances of the character string per unit of a certain number of characters (or number of bytes). Also, instead of being classified into the two ranks “high” and “low”, the “appearance frequency” may be classified into a larger number of ranks. Also, as illustrated in FIG. 15B, the “appearance frequency” may be classified into two ranks, such as “0” and “greater than 0” (this expresses whether the character string is present or not present).

### 2-3. Rule Learning

The associating of appearance frequency patterns of character strings and rules as in the examples shown in FIGS. 15A and 15B is typically carried out in advance by a learning process. The learning process may be carried out by the information processing apparatus 100 itself or may be carried out by another information processing apparatus.

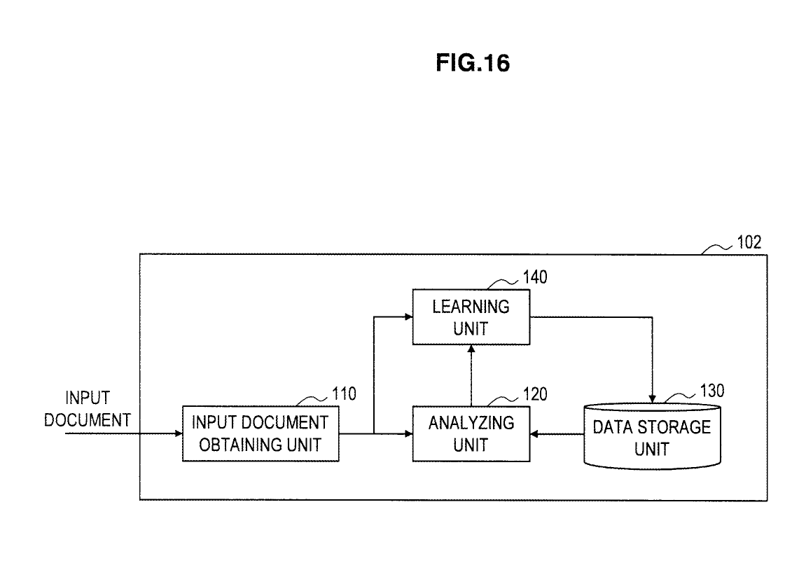

FIG. 16 is a block diagram showing one example of the configuration of an information processing apparatus 102 for learning associations between the appearance frequency patterns of character strings and rules. As shown in FIG. 16, the information processing apparatus 102 includes the input document obtaining unit 110, the analyzing unit 120, the data storage unit 130, and a learning unit 140.

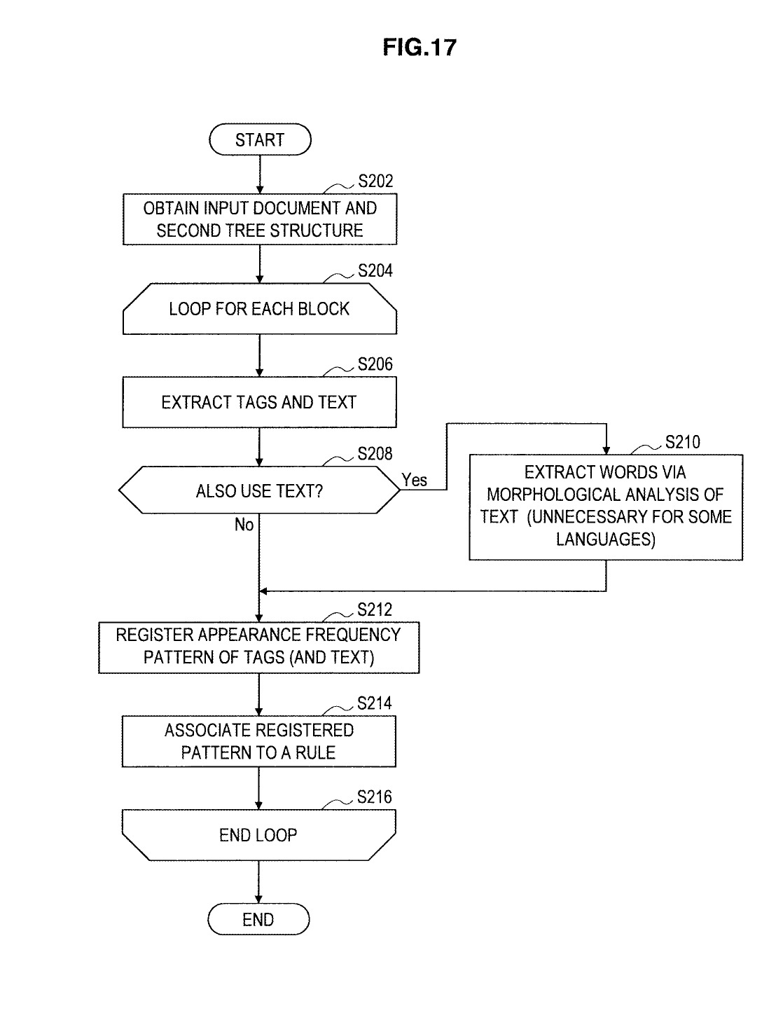

The learning unit 140 obtains an input document that is written using a markup language and is to be subjected to learning from the input document obtaining unit 110 and obtains the second tree structure described above that has been generated from such input document from the analyzing unit 120. By carrying out a learning process described below with reference to FIG. 17, the learning unit 140 learns the associations between appearance frequency patterns of character strings and rules and stores the result of such learning in the data storage unit 130.

FIG. 17 is a flowchart showing one example of the flow of the learning process carried out by the learning unit 140. As shown in FIG. 17, first, the learning unit 140 obtains the input document from the input document obtaining unit 110 and obtains the second tree structure that has been generated from the input document from the analyzing unit 120 (step S202).

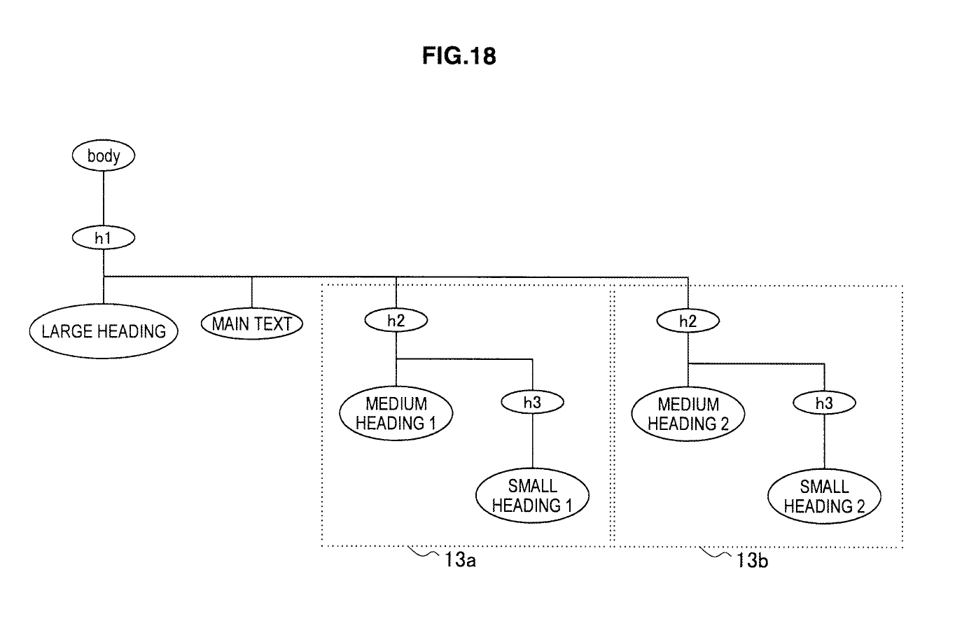

Next, the learning unit 140 enters a processing loop for each block in the input document (step S204). Here, a “block in the input document” is equivalent to a part of the input document that corresponds to a partial tree with a specific depth out of the second tree structure generated by the analyzing unit 120. As examples, a partial tree with a specific depth out of the second tree structure may be a partial tree 13a, 13b or the like in the second tree structure shown in FIG. 18 (which is the same as the structure shown in FIG. 12). In the example described here, a part corresponding to a partial tree that starts at a node two levels below the uppermost node in the second tree structure and includes nodes therebelow (or a partial tree that starts at a node two levels above a terminal node and includes nodes therebelow) is identified as a block.

In the processing loop, the learning unit 140 first extracts the tags and text from each of the blocks identified from the second tree structure (step S206). After this, when text is also being used to distinguish an appearance frequency pattern, morphological analysis is carried out on the text of the document to extract the individual words included in the text (steps S208, S210). Note that when the text is written in a language, such as English, in which individual words are already separated using symbols such as spaces, the morphological analysis may be omitted. Next, the learning unit 140 records the appearance frequency pattern of the tags (and text) in the data storage unit 130 (step S212). Here, it is possible to decide whether the appearance frequency pattern of a new block should be classified as one of the appearance frequency patterns that have already been registered using a Bayesian filter, for example. When it is not possible to classify the appearance frequency pattern of a new block as any of the appearance frequency patterns that have already been registered, such appearance frequency pattern may be registered in the data storage unit 130 as a new appearance frequency pattern. After this, the learning unit 140 associates the appearance frequency pattern registered in the data storage unit 130 with a rule that is suited to such pattern (and is already known as learning data) (step S214).

The learning unit 140 repeats the series of processes in steps S206 to S214 for each block identified from the second tree structure. When the loop has been completed for every block, the learning process ends (step S216).

### 2-4. Extraction and Storage of Snippets

The selecting unit 150 of the information processing apparatus 100 uses the rule management table illustrated in FIG. 15A or 15B and stored in advance in the data storage unit 130 as a result of the learning process described above to select the rule to be applied to each block in the input document out of at least two rules.

More specifically, for each block that is a part of the input document and corresponds to a partial tree of a specific depth out of the second tree structure generated by the analyzing unit 120, the selecting unit 150 calculates the appearance frequencies of the three types of tag “h2”, “li”, and “p” in the block. Next, the selecting unit 150 specifies a pattern corresponding to the appearance frequencies of the three types of tag. For example, when the appearance frequencies of the tags “h2” and “p” in the block being processed are high and the appearance frequency of the tag “li” is low, the pattern that is the first entry in the rule management table T1 in FIG. 15A may be specified. In this case, the selecting unit 150 selects the rule R1 associated with such pattern as the rule to be applied to extract information from the block.

Next, the extracting unit 160 extracts information from the respective blocks using the rules selected by the selecting unit 150. The extracting unit 160 stores the information extracted from each block successively into the database 170. When doing so, the extracting unit 160 attaches a label, which is a search key for information, to the information extracted from each block.

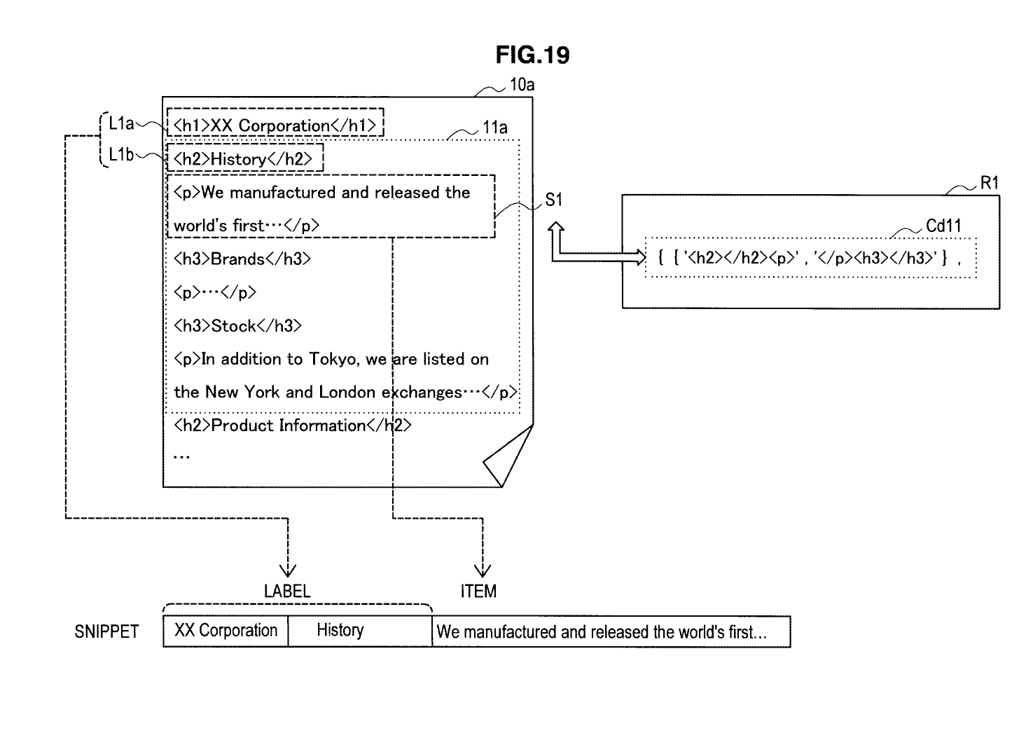

FIG. 19 is a diagram useful in explaining an information extracting process carried out by the extracting unit 160. As shown in FIG. 19, a block 11a is identified inside the input document 10a. In accordance with the appearance frequencies of the three types of tag “h2”, “li”, and “p” in the block 11a, the rule R1 is selected as the rule to be applied to the block 11a. In this example, the extracting unit 160 applies the rule R1 to the block 11a. As a result, as one example, information S1 that matches the condition Cd11 is extracted. The extracting unit 160 then appends the text L1a (“XX Corporation”) and L1b (“History”), which are marked up with the heading tags (“h1” and “h2”) that are higher-order nodes for the information S1, as labels to the extracted information Si to form a snippet. Note that the text appended as a label is not limited to this example and as other examples may be text marked up with a “title” tag that designates the title of the web page or other arbitrary text.

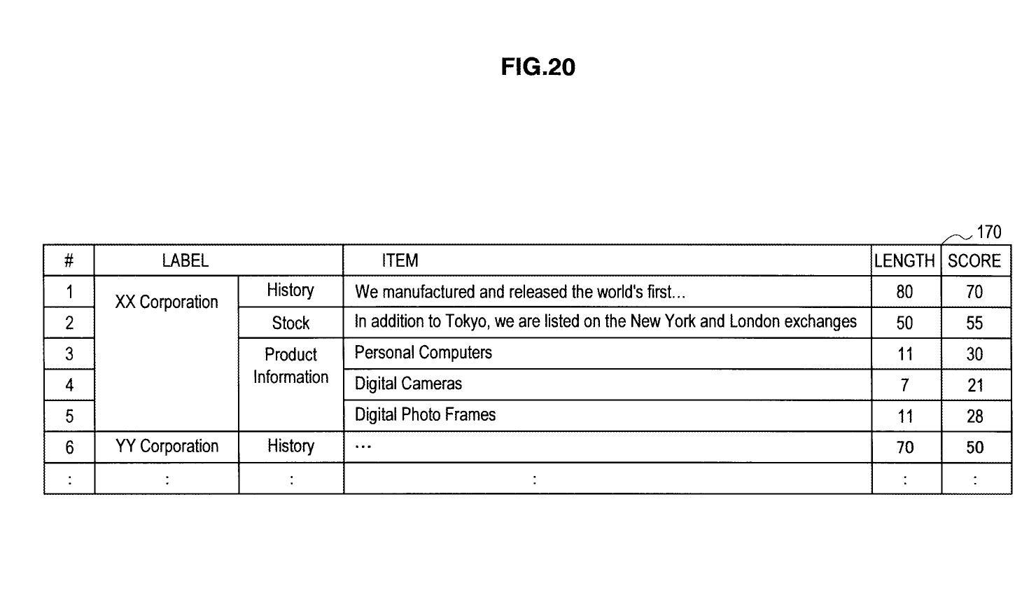

FIG. 20 is a diagram useful in explaining the snippets stored in the database 170. In the example in FIG. 20, six snippets #1 to #6 are stored in the database 170. Each snippet includes a label as a key for searching information and an item showing the content of the information. An item length (number of characters) and a score are also given for each snippet.

The snippet #1 is a snippet extracted by applying the rule R1 to the block 11a in the input document 10a in the example in FIG. 19. The item length of the snippet #1 is 80 and the score is 70. The item lengths of snippets are used to control the amount of data when snippets are provided in response to a request from the terminal apparatus 200. As one example, the score of a snippet may be a score according to TF-IDF (Term Frequency-Inverse Document Frequency) where items that include a characteristic word are assigned a high value. As an alternative example, the score of a snippet may be set so that the newer the information, the higher the score, or may be a combination of such score and TF-IDF. When snippets are provided in response to a request from the terminal apparatus 200, the scores of snippets are used to determine which snippets should be provided with priority.

### 2-5. Provision of Snippets

The searching unit 180 searches the database 170 for snippets that have labels or items that match a keyword transmitted from the terminal apparatus 200 and transmits the snippets obtained as the search result to the terminal apparatus 200. When doing so, the searching unit 180 may select snippets out of the snippets obtained from the database 170 in accordance with one or more limiting conditions, which have been transmitted from the terminal apparatus 200 and relate to display on the terminal apparatus 200, and transmit the selected snippets to the terminal apparatus 200. The requesting of snippets from the terminal apparatus 200 to the information processing apparatus 100 and the provision of snippets from the information processing apparatus 100 to the terminal apparatus 200 are described in more detail in the next section.

### 3. EXAMPLE CONFIGURATION OF TERMINAL APPARATUS

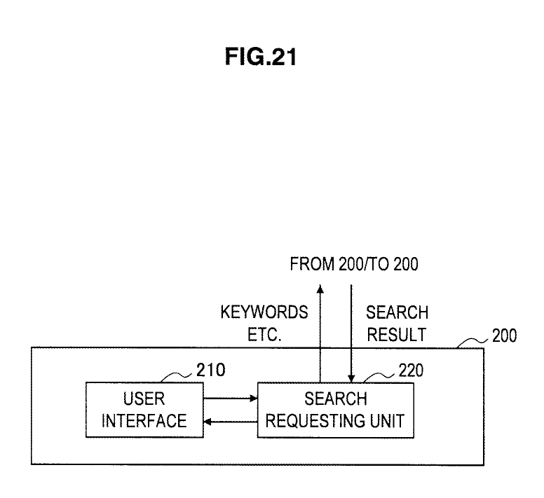

FIG. 21 is a block diagram showing one example of the overall configuration of the terminal apparatus 200 according to the present embodiment. As shown in FIG. 21, the terminal apparatus 200 mainly includes a user interface 210 and a search requesting unit 220.

### 3-1. Example of User Interface

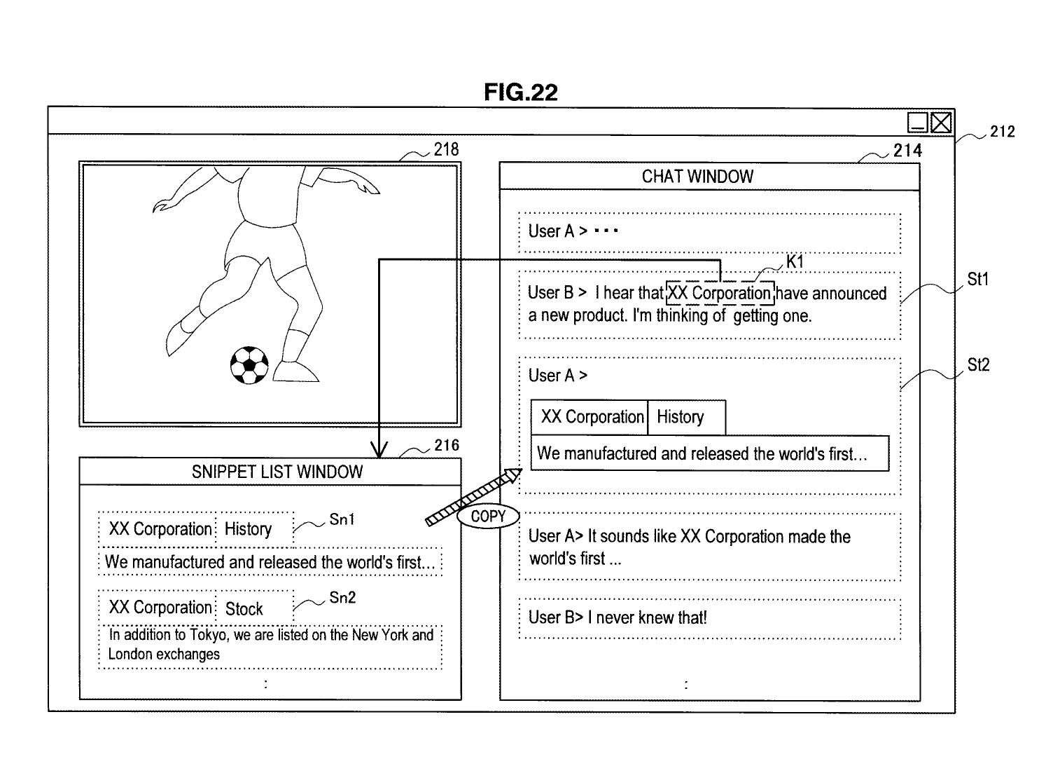

In the present embodiment, the user interface 210 includes a chat function as one example of an application that is capable of presenting snippets to the user. FIG. 22 is a diagram useful in explaining one example of a screen displayed on the screen of the terminal apparatus 200 by the user interface 210. FIG. 22 shows a screen 212 as one example of a screen displayed on the screen of the terminal apparatus 200 by the user interface 210. The screen 212 includes a chat window 214, a snippet list window 216, and a video display window 218.

The chat window 214 is a window for a chat between the user (user A) of the terminal apparatus 200 and the user (user B) of another terminal apparatus, for example. In the chat window 214, text communication between the user A and the user B is displayed in order from the top of the screen to the bottom.

The snippet list window 216 is a window for displaying a list of snippets obtained by the terminal apparatus 200 from the information processing apparatus 100. In the example in FIG. 22, snippets Sn1 and Sn2 are displayed in the snippet list window 216. As one example, the user A of the terminal apparatus 200 is capable of copying the snippet Sn1 displayed in this way in the snippet list window 216 and inserting the snippet Sn1 into one of the user's own statements in the chat window 214 (see statement St2). As one example, the snippets displayed in the snippet list window 216 are snippets that have been found and provided by the information processing apparatus 100 in accordance with a keyword K1 extracted from the chat window 214 by the search requesting unit 220.

As examples, a television program being broadcast, a movie being reproduced by the terminal apparatus 200 or being shared between the terminal apparatus 200 and the other terminal apparatus, or the like is displayed in the video display window 218. The search requesting unit 220 may use a keyword obtained (by extraction from subtitles, voice recognition, or the like) from the content being displayed in the video display window 218 in a search request for snippets that is sent to the information processing apparatus 100.

### 3-2. Search for Snippets

As one example, the search requesting unit 220 extracts characteristic search words from the statements displayed in the chat window 214 described with reference to FIG. 22. In the example in FIG. 22, the keyword “XX Corporation” is included in a statement SG by the user B. As one example, the search requesting unit 220 may generate a snippet request that requests provision of snippets that match such keyword extracted in this way from a statement and transmit the snippet request to the information processing apparatus 100.

When doing so, the search requesting unit 220 may include limiting conditions relating to display in the snippet request. As examples, the limiting conditions relating to display may include the number of snippets that are capable of being displayed or a total for the length of items for the snippet list window 216. The search requesting unit 220 then displays a list of the snippets provided from the input document obtaining unit 110 in response to the snippet request in the snippet list window 216. In the example in FIG. 22, the snippets Sn1 and Sn2 obtained by the information processing apparatus 100 in accordance with the keyword K1 are displayed in the snippet list window 216.

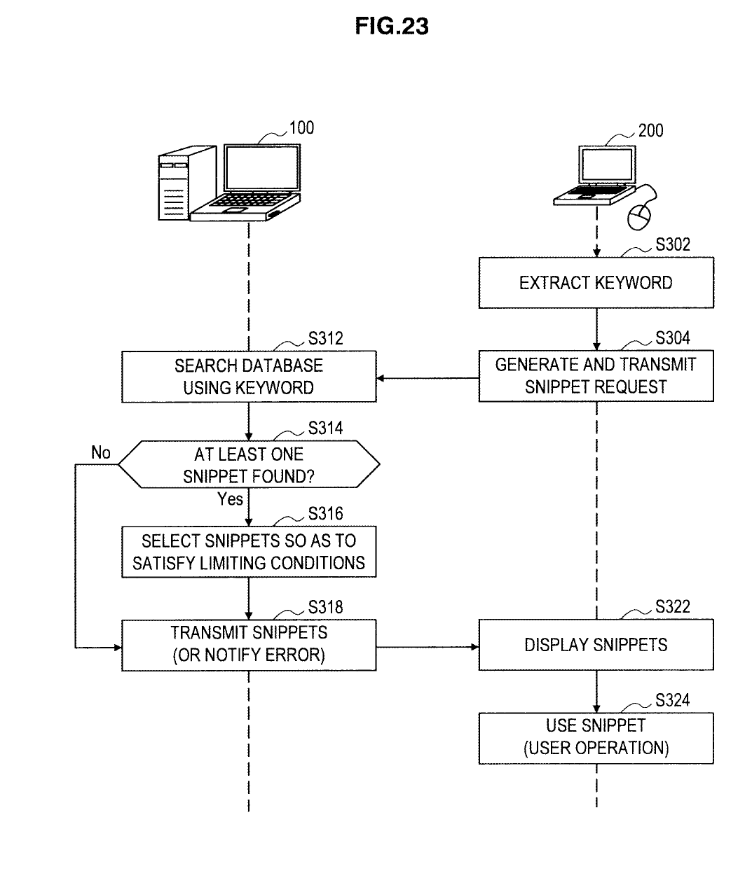

FIG. 23 is a sequence diagram showing one example of the flow of the provision of snippets from the information processing apparatus 100 to the terminal apparatus 200.

In FIG. 23, first the search requesting unit 220 of the terminal apparatus 200 extracts a keyword from a statement in the chat window 214 or from the content displayed in the video display window 218 (step S302). Next, the search requesting unit 220 generates a snippet request that includes the extracted keyword and limiting conditions for display and transmits the snippet request via the network 3 to the information processing apparatus 100 (step S304).

On receiving the snippet request from the terminal apparatus 200, the searching unit 180 of the information processing apparatus 100 searches the database 170 for snippets that match the keyword included in the snippet request. As one example, if the keyword included in the snippet request is the keyword K1 expressing “XX Corporation”, snippets #1 to #5 out of the snippets #1 to #6 illustrated in FIG. 20 are obtained (step S312). Note that when the search result does not include even one snippet (that is, when there are no snippets that match the keyword), the following processing is skipped (step S314) and the terminal apparatus 200 is notified of an error (step S318).

When at least one snippet is included in the search result, the searching unit 180 selects the snippets to be provided to the terminal apparatus 200 out of the at least one snippet so as to satisfy the limiting conditions included in the snippet request (step S316). For example, assume that for the snippet list window 216, the number of snippets that can be displayed is four and the total length of the items is 150. In this case, the searching unit 180 first selects the high-scoring snippets #1, #2, and #3 in that order out of the snippets #1 to #5 (see FIG. 20) included in the search result. At this point, the number of selected snippets is three and the total length of the items is 141. Here, if the snippet #5 (“Digital Photo Frame”) with the next highest score were selected next, the total length of the items would exceed 150 and it would not be possible to satisfy the limiting conditions. Accordingly, in this case, the searching unit 180 selects the snippet #4 (“Digital Camera”), not the snippet #5. After this, the searching unit 180 transmits the snippets #1 to #4 selected so as to satisfy the limiting conditions included in the snippet request to the terminal apparatus 200 (step S318).

On receiving the snippets (for example, the snippets #1 to #4 described above) from the information processing apparatus 100, the search requesting unit 220 of the terminal apparatus 200 displays the received snippets in the snippet list window 216 of the user interface 210 (step S322). By doing so, the user becomes able to use desired information, which is included in the snippets displayed in the snippet list window 216, during a chat (step S324).

Note that the searching unit 180 of the information processing apparatus 100 may change the score of each snippet stored in the database 170 in accordance with the number of times the snippet has been provided to the terminal apparatus 200 or the number of times the snippet has been used in the terminal apparatus 200. For example, by lowering the score of a snippet that has already been provided to the terminal apparatus 200, it is possible to avoid having the same snippet repeatedly provided to the terminal apparatus 200.

### 4. EXAMPLE OF HARDWARE CONFIGURATION

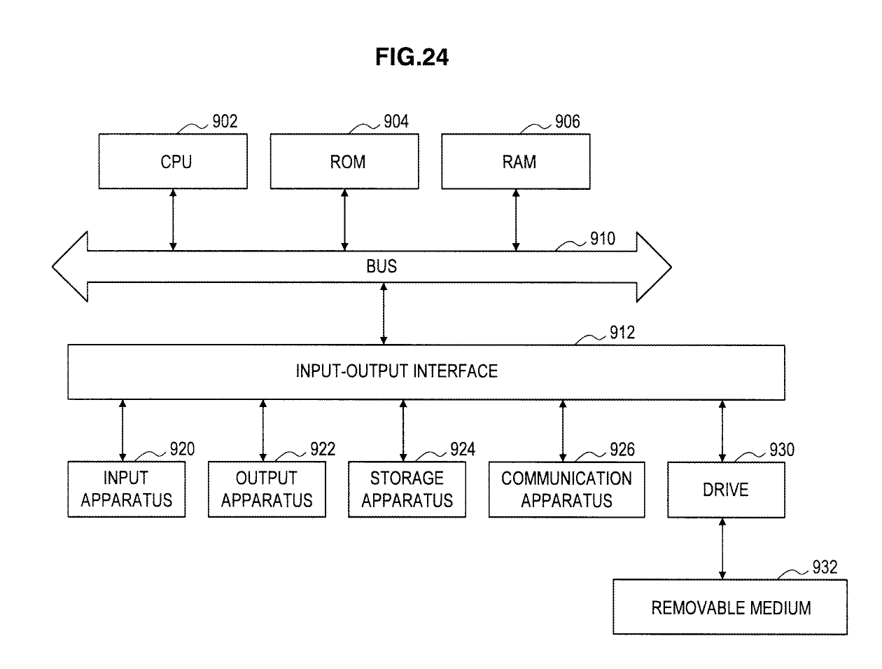

The respective functions of the information processing apparatus 100 and the terminal apparatus 200 described in the present specification may be executed using a computer incorporated in a special-purpose hardware or a general-purpose computer shown in FIG. 24.

In FIG. 24, a CPU (Central Processing Unit) 902 controls the entire operation of the general-purpose computer. A program, in which part or all of a series of processes is written, or data is stored in a ROM (Read Only Memory) 904. A program, data, and the like used by the CPU 902 when carrying out processing are temporarily stored in a RAM (Random Access Memory) 906.

The CPU 902, the ROM 904, and the RAM 906 are connected to one another via a bus 910. The bus 910 is further connected to an input-output interface 912.

The input-output interface 912 is an interface for connecting the CPU 902, the ROM 904, and the RAM 906 with an input apparatus 920, an output apparatus 922, a storage apparatus 924, a communication apparatus 926, and a drive 930.

The input apparatus 920 receives an instruction or information input from the user via an input apparatus which for example may be buttons, switches, a lever, a mouse, or a keyboard. The output apparatus 922 outputs information to the user via a display apparatus which for example may be a CRT (Cathode Ray Tube), a liquid crystal display, or an OLED (Organic Light Emitting Diode) display, or via an audio output apparatus, such as a speaker.

The storage apparatus 924 is constructed of a hard disk drive or a flash memory, for example, and stores programs, program data, and the like. The communication apparatus 926 carries out a communication process via the network 3. The drive 930 is provided in the general-purpose computer as necessary and as one example has a removable medium 932 loaded thereinto.

If the series of processes according to the embodiment of the present invention described above is carried out by software, as one example, a program stored in the ROM 904, the storage apparatus 924, or the removable medium 932 shown in FIG. 24 is written into the RAM 906 at the time of execution and is executed by the CPU 902.

### 5. CONCLUSION

One embodiment of the present invention has been described above with reference to FIGS. 1 to 24. According to the above embodiment, a rule for extracting information from a document written using a markup language is selected in accordance with the appearance frequencies of specific character strings in at least one part (that is, a block) of an input document and information is extracted from such part using the selected rule. By doing so, since only an appropriate rule out of rules that have been prepared in advance is applied to each block, there is reduced probability of unsuitable information being extracted from an information source such as a web page. For unknown web pages also, so long as the markup language used in such pages is the same, it is possible to apply the above embodiment to adaptively select a rule in accordance with the appearance frequencies of specific character strings. Accordingly, it is possible to extract meaningful information efficiently and with high precision from a wider range of information sources.

Also, in the above embodiment, the specific character strings mentioned above are tags that can be used in a markup language. For example, by making it possible to select a rule in accordance with the appearance frequencies of tags such as “h” tags that relate to headings in HTML, “ul” tags or “li” tags that relate to lists, or “p” tags that relate to paragraphs, it becomes possible to efficiently extract information from web pages written using HTML. By also using the appearance frequencies of character strings aside from tags (such as specified heading character strings), it is possible to further raise the precision with which information is extracted.

Also, in the above embodiment, blocks in the input document are identified for each partial tree in the second tree structure described above that is generated from the input document based on definition data that defines the hierarchical relationships in the document structure between at least two types of tag in a markup language. The rules to be applied are selected on a block-by-block basis and information is extracted using the selected rules. By doing so, even for an HTML document whose structure is not sufficiently described hierarchically, it is possible to appropriately select rules and extract information for each of a plurality of blocks that accurately reflect the hierarchical relationships in a document structure that can be visually understood.

Also, in the above embodiment of the present invention, information extracted from a wide range of sources using adaptively selected rules is stored in a database and is provided in response to requests from a terminal apparatus. When doing so, the information to be provided is dynamically selected in accordance with limiting conditions regarding display at the terminal. By doing so, at a terminal apparatus that realizes text communication such as chat, it is possible to easily use meaningful information to further enhance communication within a range of limiting conditions regarding display. That is, it is possible for the user to use information, which has been extracted from a wide range of sources using adaptively selected rules, during communication without having to launch a separate search screen and carry out a keyword search or the like.

Note that an example has been described above where the search requesting unit 220 of the terminal apparatus 200 automatically obtains keywords. However, the user interface 210 may be additionally provided with a text box for inputting keywords. The items that form the snippets provided from the information processing apparatus 100 to the terminal apparatus 200 are not limited to text and may include images such as portrait photographs of people or other types of data.

Although a preferred embodiment of the present invention has been described in detail with reference to the attached drawings, the present invention is not limited to the above example. It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2009-256227 filed in the Japan Patent Office on Nov. 9, 2009, the entire content of which is hereby incorporated by reference.

What is claimed is:

1. An information processing apparatus comprising:
a data storage unit storing at least two rules for extracting information from a document written using a markup language;
a selecting unit selecting, in accordance with an appearance frequency of a specific character string in at least one part of an input document written using the markup language, a rule to be applied to the part from the at least two rules stored in the data storage unit; and
an extracting unit extracting information from the part using the rule selected by the selecting unit.

2. The information processing apparatus according to claim 1,
wherein the specific character string is at least one tag that is capable of being used in the markup language.

3. The information processing apparatus according to claim 2,
wherein the selecting unit selects a rule to be applied to the part also in accordance with an appearance frequency of at least one character string other than a tag in the part.

4. The information processing apparatus according to claim 1, further comprising:
an analyzing unit generating from the input document, based on definition data that defines hierarchical relationships in a document structure between at least two types of tag in the markup language, a tree structure in which at least tags included in the definition data and text relating to the tags are set as nodes,
wherein the selecting unit selects a rule to be applied to each part of the input document, each part corresponding to a partial tree of a specific depth in the tree structure generated by the analyzing unit.

5. The information processing apparatus according to claim 1, further comprising:
a database storing information extracted on a part-by-part basis from the at least one part of the input document by the extracting unit; and
a searching unit searching the database for information that matches a keyword received from another information processing apparatus.

6. The information processing apparatus according to claim 5,
wherein the database stores the information extracted from each part of the input document in association with a heading character string corresponding to the part from which the information was extracted, and
the searching unit obtains information associated with a heading character string that matches the keyword from the database as a search result.

7. The information processing apparatus according to claim 6,
wherein the searching unit transmits information, which has been selected out of the information obtained from the database in accordance with a limiting condition relating to display received from said another information processing apparatus, to said another information processing apparatus.

8. The information processing apparatus according to claim 1,
wherein the data storage unit stores each pattern, out of at least two patterns classified in accordance with an appearance frequency of the specific character string, in association with each rule out of the at least two rules.

9. An information extracting method that uses an information processing apparatus including a data storage unit storing at least two rules for extracting information from a document written using a markup language, the information extracting method comprising the steps of:
selecting, in accordance with an appearance frequency of a specific character string in at least one part of an input document written using the markup language, a rule to be applied to the part from the at least two rules stored in the data storage unit; and
extracting information from the part using the selected rule.

10. A program for causing a computer, which controls an information processing apparatus including a data storage unit storing at least two rules for extracting information from a document written using a markup language, to function as:
a selecting unit selecting, in accordance with an appearance frequency of a specific character string in at least one part of an input document written using the markup language, a rule to be applied to the part from the at least two rules stored in the data storage unit; and
an extracting unit extracting information from the part using the rule selected by the selecting unit.

11. An information processing system comprising:
a terminal apparatus that transmits a search request including a search keyword and displays, on a user interface, information provided as a response to the search request; and
an information processing apparatus including:
a data storage unit storing at least two rules for extracting information from a document written using a markup language;
a selecting unit selecting, in accordance with an appearance frequency of a specific character string in at least one part of an input document written using the markup language, a rule to be applied to the part from the at least two rules stored in the data storage unit;
an extracting unit extracting information from the part using the rule selected by the selecting unit;
a database storing information extracted from each part out of the at least one part of the input document by the extracting unit; and
a searching unit obtaining information, which matches a search keyword received from the terminal apparatus, from the database and transmitting the obtained information to the terminal apparatus.
